(19) United States
(12) Patent Application Publication
(10) Pub. No.: US 2017/0061944 A1
(43) Pub. Date: Mar. 2, 2017

(54) ELECTRONIC MUSICAL INSTRUMENT

(71) Applicant: Roland Corporation, Shizuoka (JP)

(72) Inventor: HIROFUMI MURAMATSU, Hamamatsu (JP)

(73) Assignee: Roland Corporation, Shizuoka (JP)

(21) Appl. No.: 15/249,455

(22) Filed: Aug. 28, 2016

(30) Foreign Application Priority Data
Aug. 31, 2015 (JP) 2015-170469

(51) Int. Cl. G10H 1/32

(52) U.S. Cl. CPC G10H 1/32; G10H 2230/365

(57) ABSTRACT

Provided is a sound source module capable of inclining and capable of being easily attached and detached by a simple structure.

A sound source module 10 includes engaging portions 40 and 48 provided spaced from each other on both ends of an edge portion 14 in a longitudinal direction. A keyboard module 50 is removably engaged by the engaging portions 40 and 48. Thus, the sound source module 10 can be easily attached to and detached from the keyboard module 50. The engaging portions 40 and 48 are located on the same straight line. Thus, by a front portion 11 being supported in an inclined state relative to the keyboard module 50 with the engaging portions 40 and 48 as an axis, the sound source module 10 can be inclined relative to the keyboard module 50.

### CROSS-REFERENCE TO RELATED APPLICATION

This application claims the priority benefit of Japanese patent application no. 2015-170469, filed on Aug. 31, 2015. The entirety of the above-mentioned patent application is hereby incorporated by reference herein and made a part of this specification.

### BACKGROUND OF THE INVENTION

Field of the Invention

The invention relates to a sound source module that produces a musical sound, a keyboard module that includes a keyboard, and an electronic musical instrument.

Description of Related Art

There is an electronic musical instrument capable of giving a performance by freely combining a sound source module that forms a musical sound with a keyboard module that includes a keyboard. One example of such an electronic musical instrument is disclosed in Patent Literature 1. In the technique disclosed in Patent Literature 1, the sound source module is fixed by a screw to a rack mount member inclined relative to the keyboard module. Since the keyboard module and the sound source module can be separated from each other by removing the screw, the sound source module favored by the performer can be selected and fixed. In addition, since the sound source module can be inclined relative to the keyboard module by means of a tilt mechanism that supports the rack mount member, the selected sound source module can be inclined in a position favored by the performer for use.

### PRIOR ART LITERATURE

### Patent Literature

[Patent Literature 1] Japanese Patent Publication No. 2007-86306

### SUMMARY OF THE INVENTION

### Problems to be Solved by the Invention

However, in the above prior art, the operation of removing the screw for separating the rack mount member combined with the keyboard module and the sound source module from each other is troublesome. Hence, even though it is possible to integrate the keyboard module with the sound source module so as to carry them together to a performance scene, in the performance scene it is difficult to immediately exchange the sound source module for a desired one. In addition, there is a defect that in order to remove the screw, it is necessary to bring a tool such as a screwdriver or the like to the performance scene.

In addition, in the above prior art, the tilt mechanism that supports the rack mount member inclined relative to the keyboard module has a more complicated structure, and thus has a problem of being costly.

The invention has been accomplished in order to solve the above problems, and provides a sound source module and a keyboard module capable of inclining relative to each other and capable of being easily attached and detached by a simple structure, as well as an electronic musical instrument.

### Solution to the Problems and Effect of the Invention

To achieve the above, according to a sound source module of the first technical solution, the sound source module includes a front portion, a back portion located opposite the front portion, and an edge portion connecting the back portion and the front portion. The front portion includes a controller controlled by a user. The edge portion includes engaging portions provided spaced from each other on both ends of the edge portion in a longitudinal direction. A keyboard module including a keyboard controlled by the user is removably engaged by the engaging portions. Thus, the keyboard module can be easily attached and detached. The engaging portions are located on the same straight line. Thus, by a sound source side support portion provided in the back portion, the front portion is supported in an inclined state relative to the keyboard module that is engaged with the engaging portions with the engaging portions as an axis, and the sound source module can be inclined relative to the keyboard module. Since the same element is capable of serving as both the axis for inclining the front portion and the engaging portion, there is an effect that the sound source module and the keyboard module can be inclined relative to each other and can be easily attached and detached by a simple structure.

According to the sound source module of the second technical solution, in the engaging portion, a spring energizes a shaft portion disposed on the end in an axial direction outward in the longitudinal direction of the edge portion. By the shaft portion engaging the keyboard module, the sound source module is installed on the keyboard module. By moving the shaft portion inward in the longitudinal direction of the edge portion against the energizing force of the spring, the sound source module can be removed from the keyboard module. Thus, in addition to the effect of the first technical solution, there is an effect that the sound source module and the keyboard module can be easily installed and removed.

According to the sound source module of the third technical solution, the shaft portion and the spring are disposed on one end of the edge portion in the longitudinal direction. Thus, compared to the case where the shaft portion and the spring are disposed on both ends, the number of the shaft portion operating during installation and removal of the sound source module and the keyboard module can be decreased. Thus, in addition to the effect of the second technical solution, there is an effect that the sound source module and the keyboard module can be further easily installed and removed.

According to the sound source module of the fourth technical solution, the edge portion is capable of fixing the shaft portion by a fixing portion while the spring is compressed to cause the shaft portion to retreat toward the edge portion. Thus, a length of the shaft portion protruding from the edge portion can be reduced. Since the shaft portion can hardly protrude, in addition to the effect of the second technical solution or the third technical solution, there is an effect that the sound source module can be easily carried in a state of having been removed from the keyboard module.

According to the sound source module of the fifth technical solution, in the edge portion, a side surface connecting the both ends and the front portion is formed in a curved shape convex outward. Thus, even if a gap between the edge portion of the sound source module inclined about the engaging portions and the keyboard module is reduced, the sound source module and the keyboard module can hardly interfere with each other. Thus, in addition to the effect of any one of the first to fourth technical solutions, there is an effect that the gap between the edge portion of the sound source module and the keyboard module can be reduced.

According to a keyboard module of the sixth technical solution, the keyboard module includes a keyboard controlled by the user, and can be combined with the sound source module according to any one of the first to fifth technical solutions. In the keyboard module, the keyboard is arranged on a base, and sidewalls are provided facing each other while intersecting a straight line parallel to an arrangement direction of the keyboard. The engaging portions provided on both ends of the sound source module removably engage engaged portions provided respectively on the sidewalls. Thus, the sound source module can be easily attached to and detached from the keyboard module without an additional rack mount member. The engaged portions are located on the same straight line parallel to the arrangement direction of the keyboard. Thus, by a keyboard side support portion provided on the base, the sound source module engaged with the engaged portions is supported in an inclined state relative to the base with the engaged portions as an axis, and the sound source module can be inclined relative to the keyboard module. Since the same element is capable of serving as both the axis for inclining the sound source module and the engaged portion, there is an effect that the sound source module and the keyboard module can be inclined relative to each other and can be easily attached and detached.

According to an electronic musical instrument of the seventh technical solution, the electronic musical instrument includes the sound source module of any one of the first to fifth technical solutions and the keyboard module of the sixth technical solution in which the engaged portions are engaged with the engaging portions of the sound source module. The sound source module removably engages the engaged portions of the keyboard module by means of the engaging portions. Thus, the sound source module can be easily attached to and detached from the keyboard module. The engaging portions are located on the same straight line. Thus, by the sound source side support portion, the sound source module can be inclined relative to the keyboard module. Since the same element is capable of serving as both the axis for inclining the keyboard module and the sound source module relative to each other and the engaging portion, there is an effect that the sound source module and the keyboard module can be inclined relative to each other and can be easily attached and detached.

### BRIEF DESCRIPTION OF THE DRAWINGS

FIG. 1 is a perspective view of a sound source module according to an embodiment of the invention as viewed from a front portion side thereof.

FIG. 2 is a perspective view of the sound source module as viewed from a back portion side thereof.

FIG. 3 is a perspective view of the sound source module shown enlarging the part indicated by arrow III in FIG. 1.

FIG. 4 is a perspective view of the sound source module shown enlarging the part indicated by arrow IV in FIG. 2.

FIG. 5 is a perspective view of an engaging portion.

FIG. 6 is a perspective view of the engaging portion.

FIG. 7 is a perspective view of a keyboard module.

FIG. 8 is a perspective view of the keyboard module.

FIG. 9 is a perspective view of an electronic musical instrument as viewed from the back portion side of the sound source module.

FIG. 10 is a front view of the electronic musical instrument.

FIG. 11 is a cross-sectional view of the electronic musical instrument taken on arrows XI-XI in FIG. 10.

FIG. 12 is a cross-sectional view of the electronic musical instrument.

### DESCRIPTION OF THE EMBODIMENTS

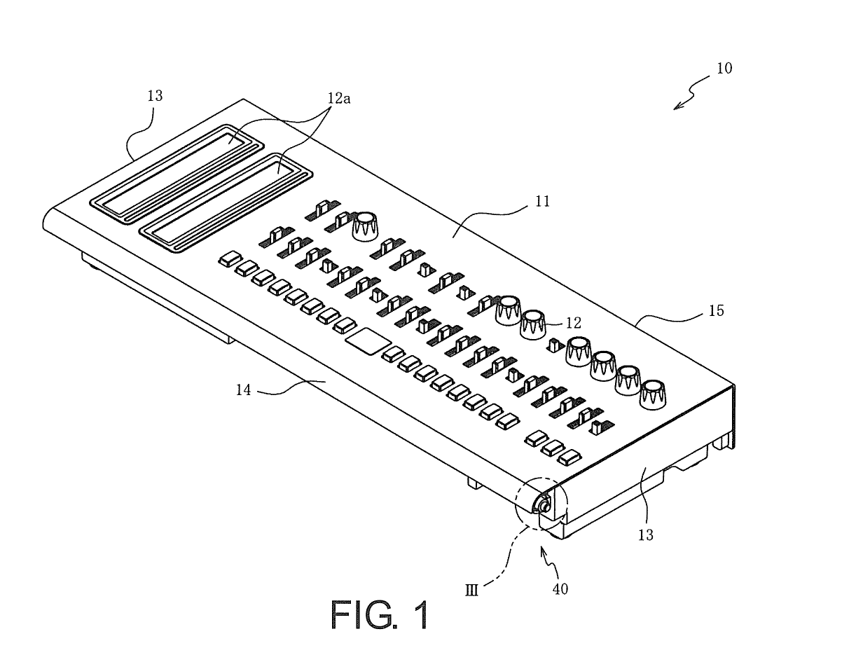

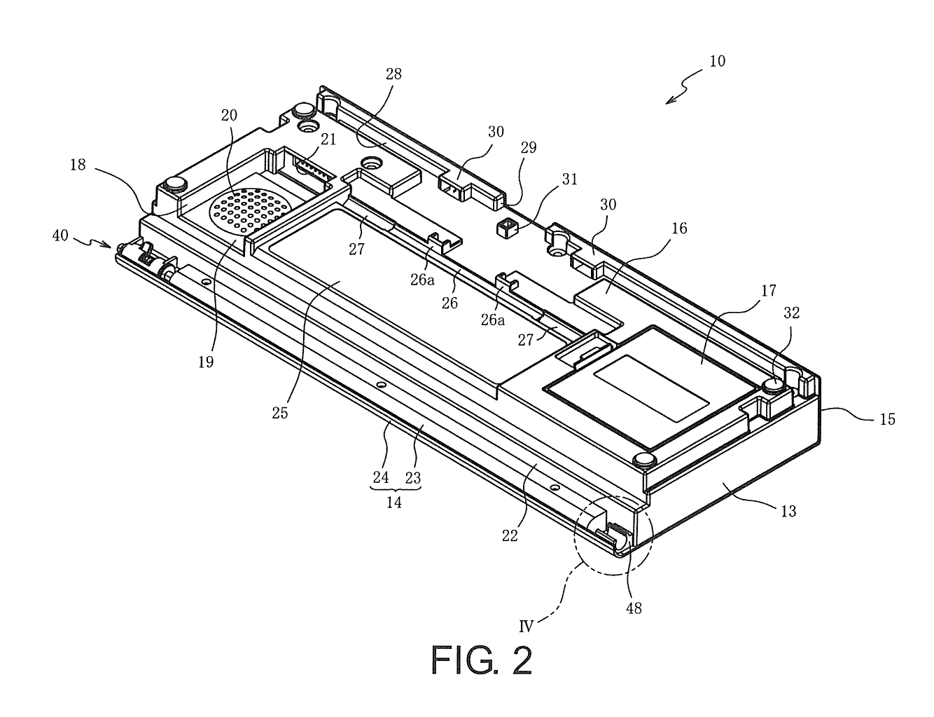

Preferred embodiments of the invention are explained hereinafter in detail with reference to the accompanying drawings. A sound source module 10 is explained with reference to FIG. 1 to FIG. 6. FIG. 1 is a perspective view of the sound source module 10 as viewed from the side of a front portion 11; FIG. 2 is a perspective view of the sound source module 10 as viewed from the side of a back portion 16. The sound source module 10 is a device for electronically producing a musical sound (reproduced sound), and is formed in a horizontally elongated rectangular plate shape. The sound source module 10 is combined with a keyboard module 50 to compose an electronic musical instrument 90 (both to be described later) called a synthesizer with a keyboard.

As shown in FIG. 1, the sound source module 10 includes: a rectangular front portion 11; rectangular first side portions 13, connected with opposing short sides of the front portion 11 and facing each other; an edge portion 14, connected with short sides of the first side portions 13 and a long side of the front portion 11; and a second side portion 15, connected with the short sides of the first side portions 13 and a long side of the front portion 11 and facing the edge portion 14. A plurality of controllers 12 controlled by a user are disposed on the front portion 11. The controllers 12 include switches or knobs for adjusting musical interval, timbre and volume of the musical sound. A ribbon controller 12a (part of the controllers 12) is an input device also capable of changing assignment of parameters and thereby giving a sound production command based on a position touched by the user.

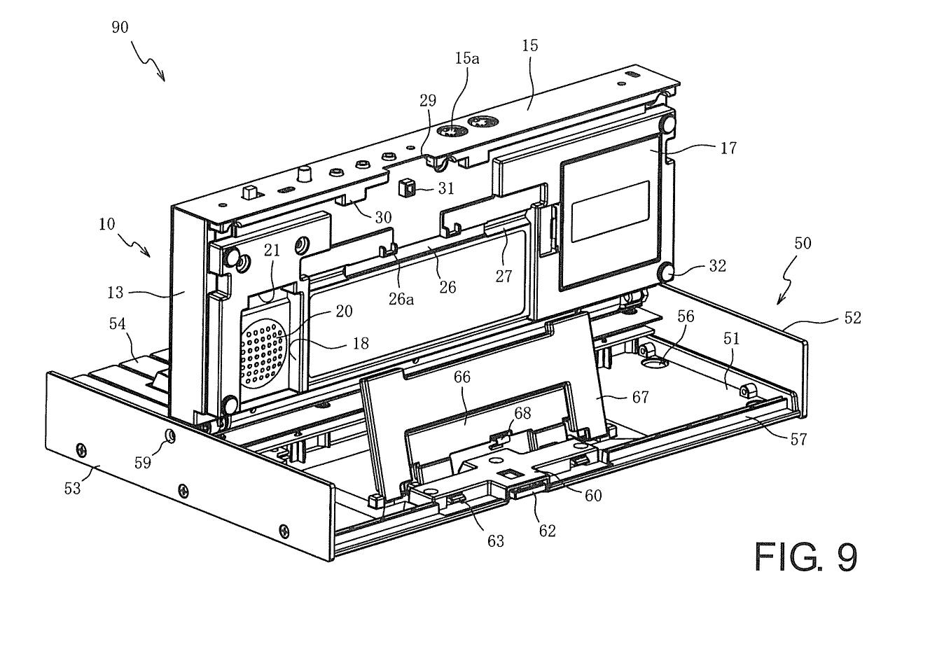

The sound source module 10 not only produces a musical sound based on control of the keyboard module 50 (to be described later), but also acts alone as an electronic musical instrument according to the sound production command from the ribbon controller 12a. In addition, the sound source module 10 is not only capable of producing a musical sound based on the control of the keyboard module 50 (to be described later) or the control of the controller 12, but is also capable of generating information (e.g., MIDI data) concerning musical sound production based on the control of the keyboard module 50 or the controller 12, and transmitting the information from an output terminal 15a (such as a MIDI output terminal and so on, see FIG. 9) provided on the second side portion 15 so as to cause an external sound source machine (not illustrated) to produce sound.

As shown in FIG. 2, the sound source module 10 includes a rectangular back portion 16 opposite the front portion 11 (see FIG. 1). An accommodating portion 17 and a speaker 20 are provided respectively on both sides (close to the first side portions 13) of the back portion 16 in a longitudinal direction. The accommodating portion 17 is a part that accommodates a battery for supplying electricity, and an electrode connected to the battery is disposed therein. The battery is a power source of the electronic musical instrument 90 (to be described later). FIG. 2 illustrates a state in which a cover of the accommodating portion 17 is closed (i.e., a state in which the battery is invisible). The speaker 20 is a device for emitting a musical sound produced by the sound source module 10, and is disposed on a bottom surface 19 of a first concave portion 18 formed in a square shape in rear view.

Except for the side closer to the edge portion 14, the first concave portion 18 has three sides surrounded by walls, wherein a connector 21 is provided on the wall closer to the second side portion 15. In the first concave portion 18, the wall facing the connector 21 is omitted (open). Thus, the bottom surface 19 of the first concave portion 18 is connected with an end surface 22 of the back portion 16 toward the edge portion 14. The end surface 22 is formed in a step shape, and a base portion 23 extending along a long side of the back portion 16 is provided on the end surface 22 closer to the front portion 11. The base portion 23 is a part that supports a side surface 24 connecting both ends of the edge portion 14 in the longitudinal direction and the front portion 11. The base portion 23 and the side surface 24 are parts forming part of the edge portion 14, wherein a cross section of the side surface 24 orthogonal to the long side is formed in a curved shape convex outward and is connected with the front portion 11.

In the back portion 16, a second concave portion 25 having a rectangular shape in rear view is formed between the accommodating portion 17 and the speaker 20. The second concave portion 25 is a depression connected with the end surface 22. In the second concave portion 25, a first depression 26 and a second depression 27 (sound source side support portion) extending parallel to the edge portion 14 are formed in the center of the back portion 16 in the transverse direction. The second depression 27 is located closer than the first depression 26 to both sides of a base 51 in the longitudinal direction. In the second concave portion 25, a first convex portion 26a protrudes from a side of a boundary between the first depression 26 and the second concave portion 25 far from the edge portion 14 in a thickness direction of the back portion 16. There are provided two first convex portions 26a, spaced apart at a predetermined spacing (the spacing being narrower than a width of a first stand 66 (to be described later)) in the longitudinal direction of the base 51.

In the back portion 16, a transverse groove 28 extending along the long side of the back portion 16 is formed both between the accommodating portion 17 and the second side portion 15 and between the speaker 20 and the second side portion 15. The transverse groove 28 is connected with the second concave portion 25, and the second concave portion 25 is connected with the second side portion 15 by a break 29 formed along the long side of the back portion 16. In the back portion 16, protrusions 30 extending from the second side portion 15 toward the first depression 26 (from the end toward the center in the transverse direction) are provided on both sides of the break 29 of the second concave portion 25. In the back portion 16, a second convex portion 31 that protrudes in the thickness direction is provided in the second concave portion 25 close to the break 29. In the back portion 16, legs 32 that protrude in the thickness direction are provided on four corners. In the sound source module 10, engaging portions 40 and 48 are provided on the both ends of the edge portion 14 in the longitudinal direction.

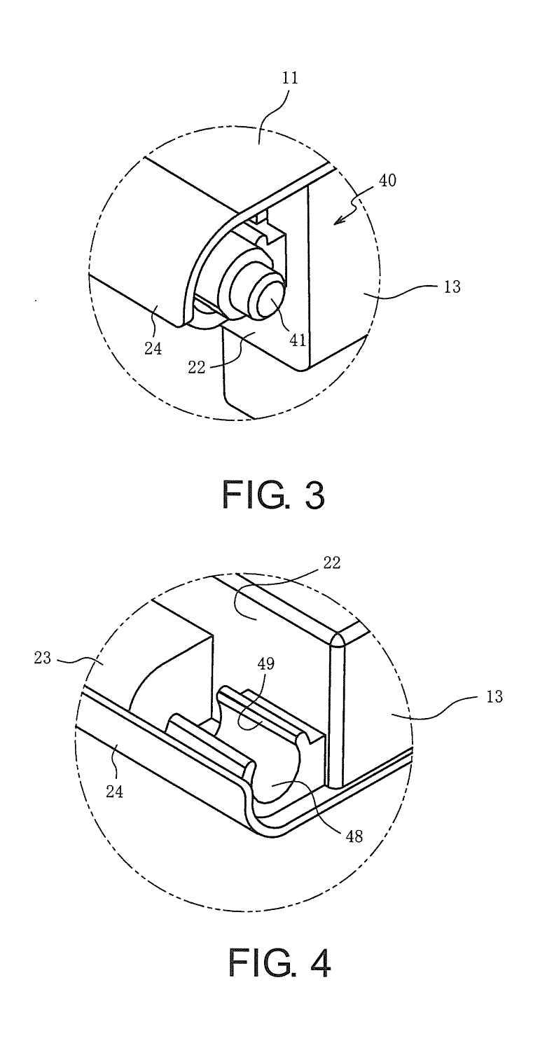

The engaging portions 40 and 48 are explained with reference to FIG. 3 to FIG. 6. The engaging portions 40 and 48 are parts that combine the sound source module 10 with the keyboard module 50 (to be described later). FIG. 3 is a perspective view of the sound source module 10 shown enlarging the part indicated by arrow III in FIG. 1. The engaging portion 40 includes a shaft portion 41 disposed behind the side surface 24 of the edge portion 14. The shaft portion 41 is formed in a cylindrical shape, having an axial direction consistent with the long side direction of the edge portion 14 and a tip protruding outward of the first side portion 13.

FIG. 4 is a perspective view of the sound source module 10 shown enlarging the part indicated by arrow IV in FIG. 2. The engaging portion 48 is a part formed U-shaped in cross-section, disposed on an inside surface of the curved side surface 24 and outside the base portion 23 in the longitudinal direction. In the engaging portion 48, a cut 49 extending in a direction consistent with the longitudinal direction of the edge portion 14 is formed on a cylindrical wall surface. Due to the cut 49, a portion (the part combined with the side surface 24 and the part on the opposite side) of the circumference of the cylindrical wall surface is removed throughout the axial direction. Due to the cut 49, the cross section of the engaging portion 48 orthogonal to the longitudinal direction of the edge portion 14 is in the shape of a superior arc. The axial center of the engaging portion 48 and the shaft center of the shaft portion 41 (see FIG. 3) are located on the same straight line along the longitudinal direction of the edge portion 14. A tip of the engaging portion 48 is located inward (left side in FIG. 4) of an end surface of the side surface 24 in the longitudinal direction.

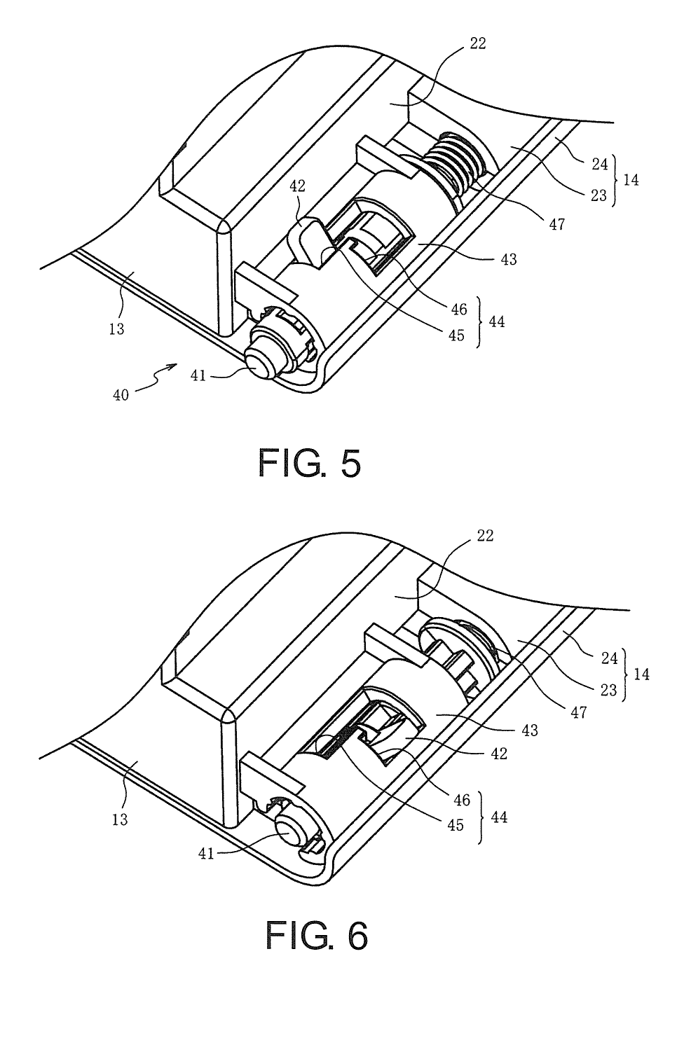

The engaging portion 40 is explained with reference to FIG. 5 and FIG. 6. FIG. 5 and FIG. 6 are perspective views of the engaging portion 40. In the engaging portion 40, the shaft portion 41 extending in the longitudinal direction of the edge portion 14 is a part that enters and exits the edge portion 14. As shown in FIG. 5, the engaging portion 40 includes: the shaft portion 41; a lever 42, integrated with the shaft portion 41 and protruding radially outward from a side surface of the shaft portion 41; a cylindrical surrounding portion 43, surrounding the shaft portion 41; and a spring (coil spring) 47, disposed between an end (rear end) of the shaft portion 41 in the axial direction and the base portion 23. The shaft portion 41 is energized outward in the axial direction by the spring 47.

The surrounding portion 43 is a member that supports the shaft portion 41 in a manner that the shaft portion 41 is movable in the axial direction, disposed on the inside surface of the curved side surface 24 and outside the base portion 23 in the longitudinal direction. In the surrounding portion 43, a groove portion 44 is formed into which the lever 42 is inserted, wherein a tip of the lever 42 protrudes radially outward of the surrounding portion 43. The groove portion 44 includes a first groove 45, and a second groove 46 extending in the circumferential direction of the surrounding portion 43 from the first groove 45.

An inner surface of the first groove 45 on a longitudinal outer side (right side in FIG. 5) of the edge portion 14 is located more toward an axial outer side (tip side of the shaft portion 41) of the surrounding portion 43 than an inner surface of the second groove 46 on the longitudinal outer side of the edge portion 14. A length of the first groove 45 in the axial direction is set greater than that of the second groove 46. As shown in FIG. 5, when the lever 42 of the shaft portion 41 energized by the spring 47 touches the inner surface of the first groove 45, the tip of the shaft portion 41 protrudes outward of the end surface of the side surface 24 in the longitudinal direction. At this moment, due to elastic deformation of the spring 47, the tip of the shaft portion 41 can retreat to the same position as the end surface of the side surface 24 in the longitudinal direction.

As shown in FIG. 6, when the user moves the lever 42 (part of a fixing portion) from the first groove 45 to touch the inner surface of the second groove 46 (part of the fixing portion) against the energizing force from the spring 47, the spring 47 maintains a compressed state, and the tip of the shaft portion 41 is located inward of (or at the same position as) the end surface of the side surface 24 in the longitudinal direction. Accordingly, since the shaft portion 41 can be prevented from protruding outward of the edge portion 14 (side surface 24) in the longitudinal direction, when the sound source module 10 is being carried and so on, the shaft portion 41 can be prevented from bumping into a mating member and damaging itself and the mating member. In addition, since the shaft portion 41 does not protrude in the width direction of the sound source module 10, the width of the sound source module 10 can be reduced as much as an amount of the shaft portion 41 reduced, and the sound source module 10 can be easily carried.

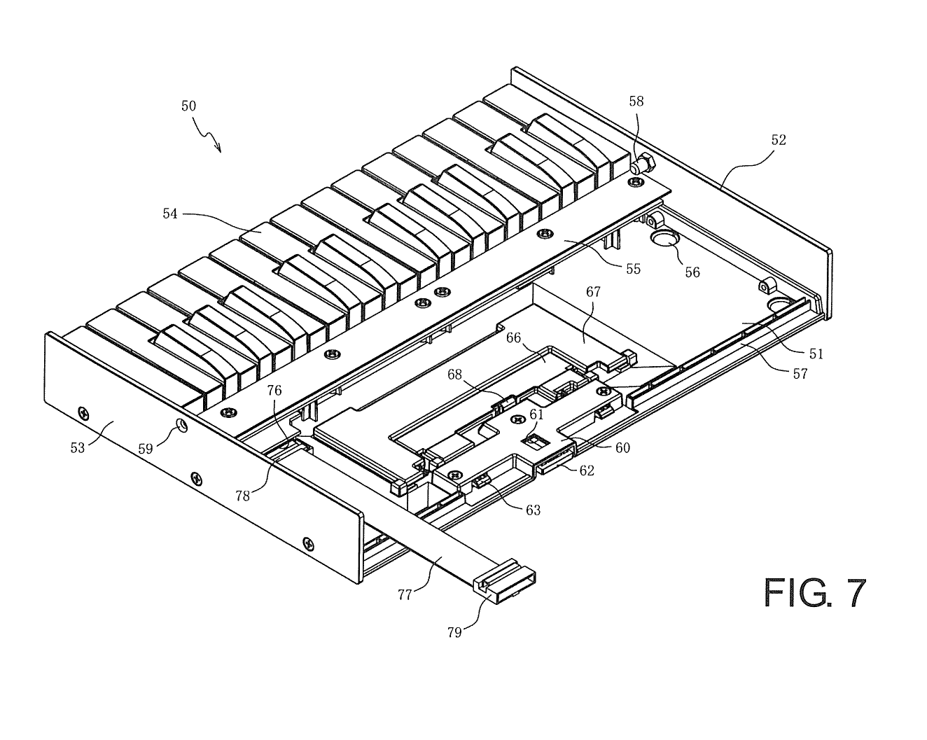

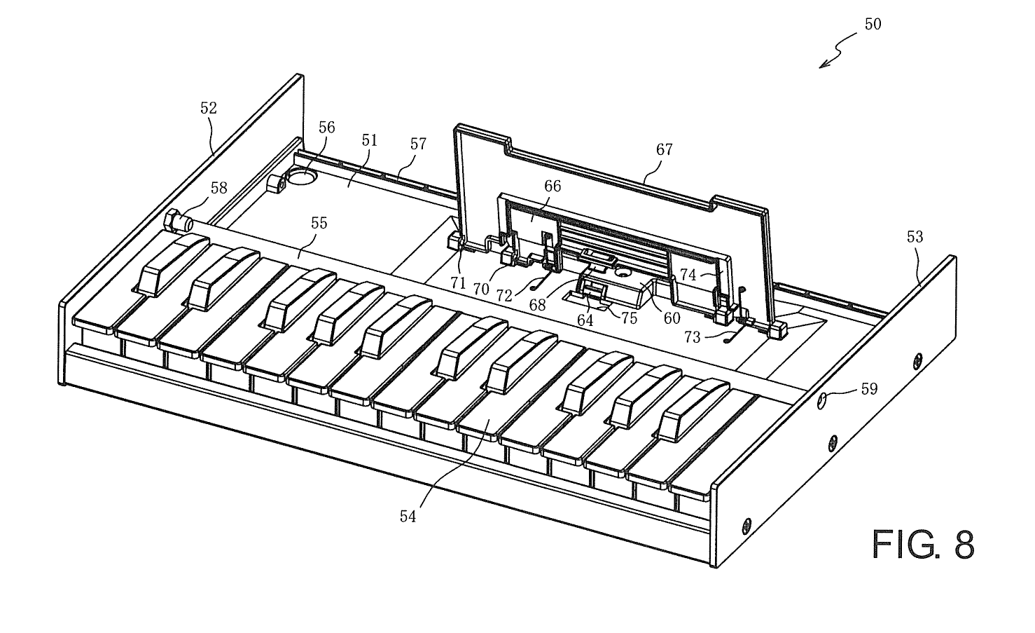

The keyboard module 50 is explained with reference to FIG. 7 and FIG. 8. FIG. 7 and FIG. 8 are perspective views of the keyboard module 50. FIG. 7 illustrates a state in which the first stand 66 and a second stand 67 (to be described later) are laid, and a flat cable 77 is connected. However, a middle part of the flat cable 77 is omitted from FIG. 7. FIG. 8 illustrates a state in which the first stand 66 and the second stand 67 have been stood.

As shown in FIG. 7, the keyboard module 50 is a device in which a keyboard 54 is disposed that triggers sound production according to the user's control, formed in a horizontally elongated rectangular plate shape. The keyboard module 50 includes: a horizontally elongated rectangular board-like base 51; board-like sidewalls 52 and 53, disposed upright facing each other on short sides of the base 51; and the keyboard 54, disposed on the base 51 between the sidewalls 52 and 53 and having an arrangement direction consistent with a direction in which long sides of the base 51 extend.

The keyboard 54 has a width (dimension in the arrangement direction) set almost equal to the length of the long side of the base 51, and a depth set to approximately half the length of the short side of the base 51. As a result, on the base 51, an empty space without the keyboard 54 is formed in a region sandwiched between the sidewalls 52 and 53 on a deep side (right near side in FIG. 7) of the keyboard 54 in the depth direction. Since the spacing between the sidewalls 52 and 53 is set slightly larger than the width of the sound source module 10 (see FIG. 1), the sound source module 10 is installed in the empty space between the sidewalls 52 and 53 on the base 51. After the installation, the width of the sound source module 10 is almost equal to the spacing between the sidewalls 52 and 53. Thus, the sound source module 10 can be handled in an integrated manner as one electronic musical instrument similarly as general electronic musical instruments. For example, when carried and so on, by the board-like sidewalls 52 and 53, the sound source module 10 can be prevented from bumping into a mating member and damaging itself and the mating member.

In the keyboard module 50, a horizontally elongated transverse board 55 is disposed next to the deep side of the keyboard 54 in the depth direction. The transverse board 55 is disposed at approximately half the height of the sidewalls 52 and 53, and has a length set almost equal to the length of the long side of the base 51. A substrate having an electric circuit formed thereon is fixed to the back of the transverse board 55.

Depressions 56 are formed at four places in the base 51. The depressions 56 are parts that accommodate the legs 32 of the sound source module 10. A ridge-like ridge portion 57 is provided along the long side of the base 51 except the center of the long side. The ridge portion 57 is a part that improves rigidity of the base 51 and is accommodated in the transverse groove 28 of the sound source module 10. By the depressions 56 of the base 51 and the transverse groove 28 of the sound source module 10, the base 51 (ridge portion 57) and the sound source module 10 (legs 32) can be prevented from interfering with each other.

A protruding portion 58 and a hole portion 59 (engaged portions) are provided respectively on the sidewalls 52 and 53 above the transverse board 55. The protruding portion 58 is a cylindrical, shaft-like member protruding from the sidewall 52 toward the sidewall 53; the hole portion 59 is a circular through hole passing through the sidewall 53 in the thickness direction. The shaft center of the protruding portion 58 and the center of the hole portion 59 are located on the same straight line parallel to the long side of the base 51. A diameter of the protruding portion 58 is set slightly less than an inner diameter of the engaging portion 48 of the sound source module 10, and an inner diameter of the hole portion 59 is set slightly greater than a diameter of the shaft portion 41 of the sound source module 10. The diameter of the protruding portion 58 is set greater than a width of the cut 49 (spacing in the circumferential direction) forming in the engaging portion 48 of the sound source module 10.

At the center part of the long side of the base 51 where the ridge portion 57 is omitted, a cover 60 being cross-shaped in plan view is disposed. The cover 60 is a board-like member for ensuring the space from the base 51, having an insertion hole 61 formed passing therethrough in the thickness direction. The cover 60 is provided in a position corresponding to the break 29 of the sound source module 10. The insertion hole 61 is a part in which the second convex portion 31 of the sound source module 10 is inserted. A moving portion 62 being cross-shaped in plan view is disposed between the base 51 and the cover 60, having an end sticking out of the cover 60. The moving portion 62 is a board-like member that moves, according to the user's control, between the base 51 and the cover 60 in the short side direction of the base 51, and is formed integrally with a claw portion 63 sticking out of the cover 60. The claw portion 63 is a part that engages the protrusion 30 of the sound source module 10, sticking toward the deep side (right near side in FIG. 7) of the keyboard 54 in the depth direction.

The first stand 66 (keyboard side support portion; part of a stand) and the second stand 67 (keyboard side support portion; part of the stand) are members for maintaining the inclined state of the sound source module 10 relative to the keyboard module 50. An engaging piece 68 is fixed to the first stand 66. The engaging piece 68 is a member for maintaining the laid state of the first stand 66 and the second stand 67 on the base 51.

As shown in FIG. 8, the first stand 66 and the second stand 67 are formed in a gate shape and are fixed to the base 51 respectively by shafts 70 and 71 disposed close to the cover 60. Torsion springs 72 and 73 are members that energize the first stand 66 and the second stand 67 in a standing-up direction about the shafts 70 and 71, and are disposed respectively on the shafts 70 and 71. The second stand 67 is disposed outside the first stand 66. Thus, a height of the second stand 67 when standing is set greater than a height of the first stand 66 when standing. A receiving portion 74 that interferes with the first stand 66 is provided on the second stand 67. When the first stand 66 and the second stand 67 are laid on the base 51, the receiving portion 74 is located between the base 51 and the first stand 66.

A through hole 75 passing through the base 51 in the thick direction is formed in a position on the base 51 facing a tip portion 64 of the moving portion 62. The through hole 75 is a part at which the tip portion 64 of the moving portion 62 is disposed and in which the engaging piece 68 is inserted when the first stand 66 and the second stand 67 are laid down.

Please refer back to FIG. 7. In the keyboard module 50, a connector 76 is disposed on an end surface of the keyboard 54 between the transverse board 55 and the base 51. The connector 76 is connected to the connector 21 of the sound source module 10 by the soft flat cable 77 in which a power supply wiring and a signal wiring are arranged side by side. The flat cable 77 has both ends connected respectively to connectors 78 and 79. The flat cable 77 supplies electricity from the sound source module 10 to the keyboard module 50 by the power supply wiring, and transmits information (key pressing related information) of the user's control of the keyboard 54 from the keyboard module 50 to the sound source module 10 by the signal wiring. Since the electricity required by the keyboard module 50 is supplied by sound source module 10, a battery accommodating portion or the like can be omitted from the keyboard module 50. Thus, the structure of the keyboard module 50 can be simplified.

The electronic musical instrument 90 is explained with reference to FIG. 9 to FIG. 12. The electronic musical instrument 90 is a device in which the engaging portions 40 and 48 of the sound source module 10 are mechanically connected with the protruding portion 58 and the hole portion 59 (engaged portions) of the keyboard module 50, and the sound source module 10 is electrically connected with the keyboard module 50 by the flat cable 77. FIG. 9 is a perspective view of the electronic musical instrument 90 as viewed from the back portion side of the sound source module 10.

As mentioned above, the diameter of the protruding portion 58 of the keyboard module 50 is set slightly less than the inner diameter of the engaging portion 48 of the sound source module 10, and the inner diameter of the hole portion 59 of the keyboard module 50 is set slightly greater than the diameter of the shaft portion 41 of the sound source module 10. Thus, the engaging portions 40 and 48 of the sound source module 10 can engage respectively the hole portion 59 and the protruding portion 58 (engaged portions) of the keyboard module 50. The engaging portions 40 and 48, the hole portion 59 and the protruding portion 58 are respectively located on the same straight line. Thus, as shown in FIG. 9, the inclination of the sound source module 10 relative to the keyboard module 50 can be changed with the engaging portions 40 and 48, the hole portion 59 and the protruding portion 58 as an axis. The diameter of the protruding portion 58 is set greater than the width of the cut 49 of the engaging portion 48. Thus, when the inclination of the sound source module 10 relative to the keyboard module 50 is changed with the engaging portion 48 and the protruding portion 58 as an axis, the protruding portion 58 inserted in the engaging portion 48 can be prevented from being withdrawn from the cut 49.

Here, to engage the engaging portions 40 and 48 of the sound source module 10 with the hole portion 59 and the protruding portion 58 of the keyboard module 50, first of all, the lever 42 of the engaging portion 40 of the sound source module 10 is put into the first groove 45 to enable the shaft portion 41 to displace axially. Next, the protruding portion 58 of the keyboard module 50 is inserted in the engaging portion 48 of the sound source module 10 from an end. Since the engaging portion 48 includes the cut 49, by use of the cut 49, the protruding portion 58 can be put on the engaging portion 48 from an oblique direction intersecting an axis of the protruding portion 58.

After the protruding portion 58 of the keyboard module 50 is put on the engaging portion 48 of the sound source module 10, the tip of the shaft portion 41 is pushed in the axial direction, and as the tip of the shaft portion 41 runs into the sidewall 53, the tip of the shaft portion 41 approaches the position of the hole portion 59 of the sidewall 53. When the shaft portion 41 matches the hole portion 59, the spring 47 is restored so that the shaft portion 41 is inserted into the hole portion 59 and the shaft portion 41 engages the hole portion 59. Since the shaft portion 41 is energized by the spring 47 to displace axially, the sound source module 10 can be easily installed on the keyboard module 50.

In addition, to remove the engaging portions 40 and 48 of the sound source module 10 from the hole portion 59 and the protruding portion 58 of the keyboard module 50, by using a pin or the like, the tip of the shaft portion 41 inserted into the hole portion 59 is pushed in the axial direction to pull the shaft portion 41 out of the hole portion 59. In that state, while the position of the first side portion 13 of the sound source module 10 is shifted relative to the sidewall 53 of the keyboard module 50, the sound source module 10 is moved in an oblique direction intersecting the axis of the protruding portion 58 of the keyboard module 50 to pull the protruding portion 58 out of the engaging portion 48. Since the engaging portion 40 energizes the shaft portion 41 outward in the axial direction by means of the spring 47, the sound source module 10 and the keyboard module 50 can be easily installed and removed.

The shaft portion 41 and the spring 47 are disposed on one end of the edge portion 14 in the longitudinal direction. Thus, compared to the case where the shaft portion 41 and the spring 47 are disposed on both ends of the edge portion 14, the number of the shaft portion 41 operating during installation and removal of the sound source module 10 and the keyboard module 50 can be decreased. Thus, the sound source module 10 and the keyboard module 50 can be easily installed and removed.

Since the shaft portion 41 is inserted in the hole portion 59 that passes through the sidewall 53, by applying an axial force to the shaft portion 41 through the hole portion 59, the shaft portion 41 can be pushed out of the hole portion 59. Accordingly, the sound source module 10 can be easily detached from the keyboard module 50.

The hole portion 59 and the protruding portion 58 (engaged portions) of the keyboard module 50 are provided close to upper edges of the sidewalls 52 and 53. Thus, compared to the case where the engaged portions are provided close to the base 51 of the sidewalls 52 and 53, an angle formed between the axis of the protruding portion 58 and the sound source module 10 when the sound source module 10 and the keyboard module 50 are installed and removed can be reduced. Thus, the sound source module 10 can be easily installed and removed.

Moreover, the method for engaging the engaging portion 40 of the sound source module 10 with the hole portion 59 of the keyboard module 50 and the method for pulling the engaging portion 40 out of the hole portion 59 are not limited to the aforementioned methods. For example, to engage the engaging portion 40 with the hole portion 59, the lever 42 (see FIG. 6) is put into the second groove 46, and after the tip of the shaft portion 41 is positioned in the position of the hole portion 59 of the sidewall 53, the lever 42 is put into the first groove 45 to insert (engage) the shaft portion 41 into (with) the hole portion 59. To pull the engaging portion 40 out of the hole portion 59, the lever 42 may be put from the first groove 45 into the second groove 46. Similar to the aforementioned method, by this method, the sound source module 10 and the keyboard module 50 can also be easily installed and removed.

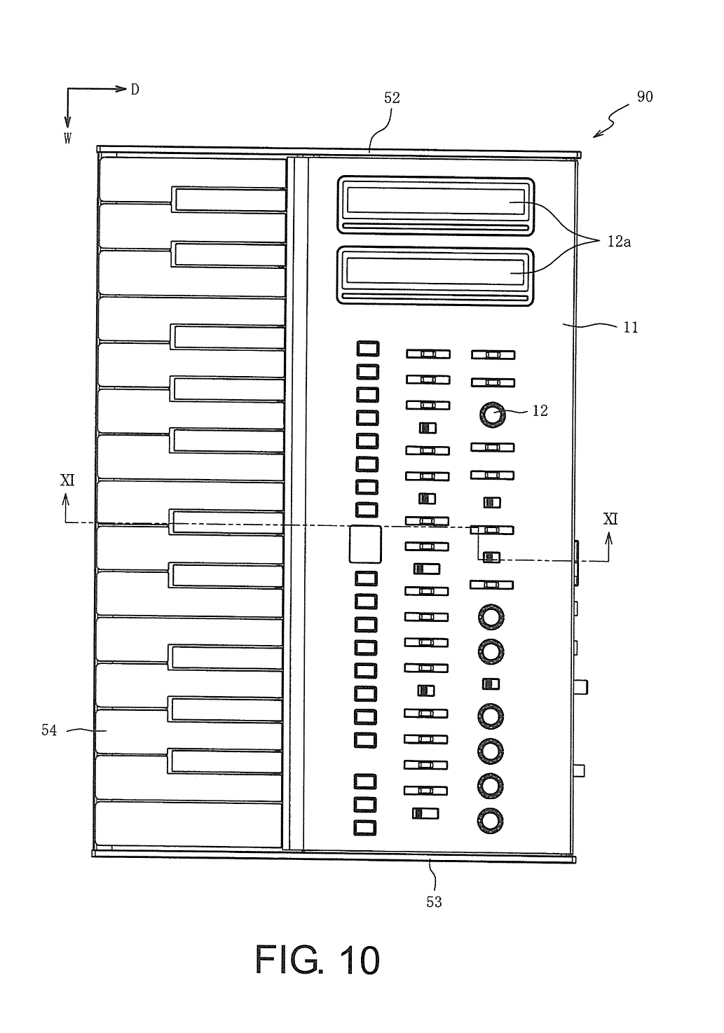

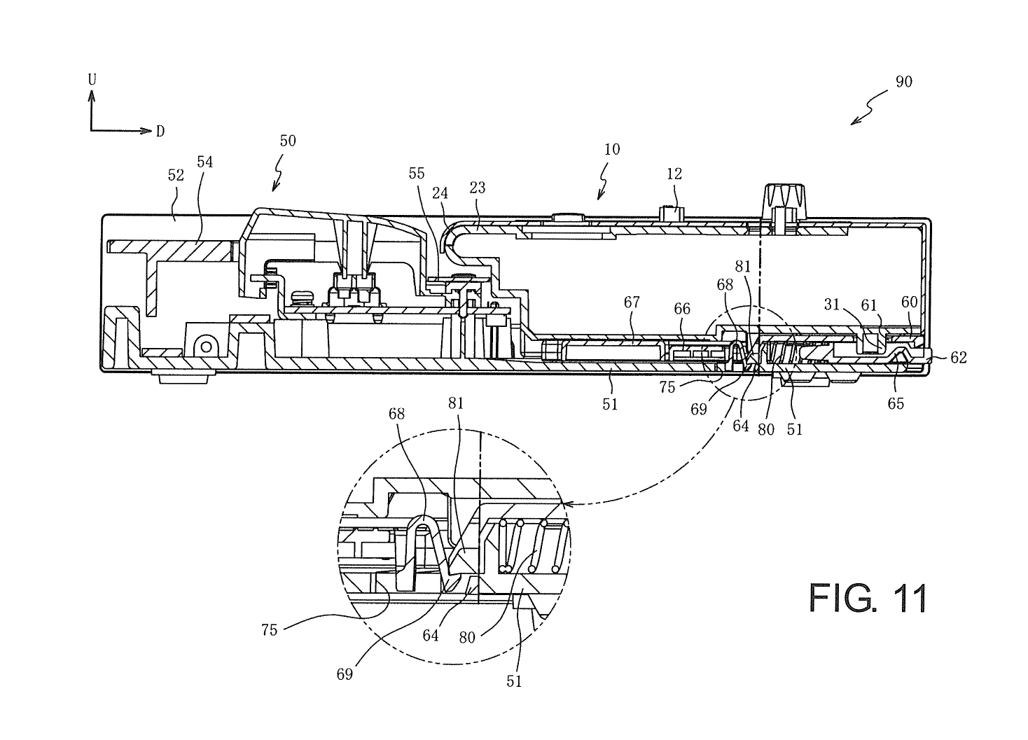

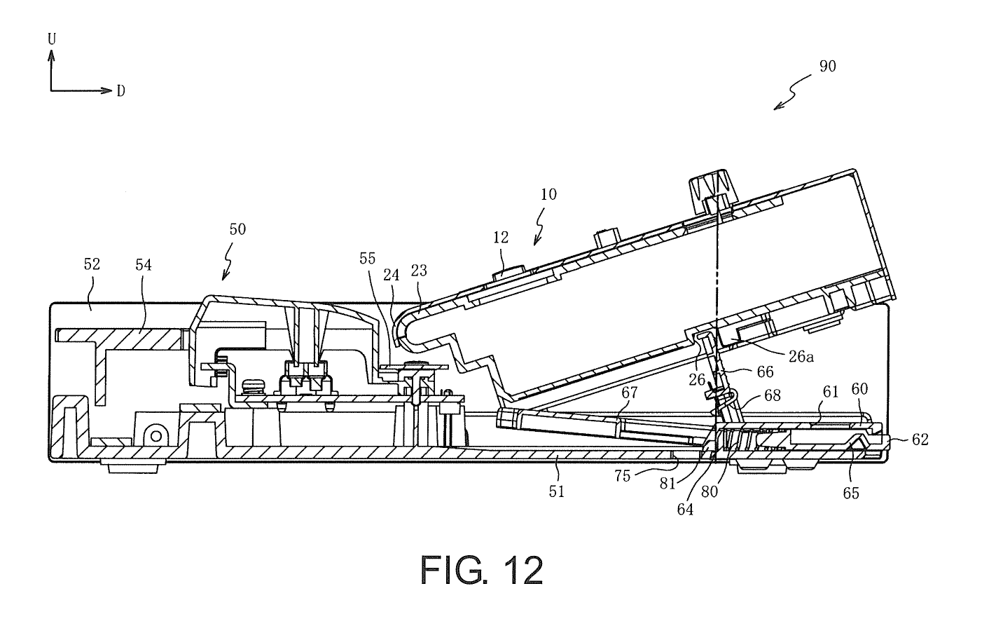

A mechanism inclining the sound source module 10 relative to the keyboard module 50 is explained with reference to FIG. 10 to FIG. 12. FIG. 10 is a front view of the electronic musical instrument 90 having the sound source module 10 in a flat state; FIG. 11 is a cross-sectional view of the electronic musical instrument 90 taken on arrows XI-XI in FIG. 10; and FIG. 12 is a cross-sectional view of the electronic musical instrument 90 in which the sound source module 10 is supported by the first stand 66. Arrow W shown in FIG. 10 means the width direction of the keyboard instrument (electronic musical instrument 90); arrow D shown in FIG. 10 to FIG. 12 means the deep side of the keyboard 54 in the depth direction; and arrow U shown in FIG. 11 and FIG. 12 means the above of the electronic musical instrument 90. In FIG. 11 and FIG. 12, to facilitate understanding, the internal structure of the sound source module 10 is omitted from illustration.

As shown in FIG. 11, in the keyboard module 50, an inclined portion 65 is provided on a surface of the moving portion 62 toward the cover 60, protruding toward the cover 60. The inclined portion 65 is disposed between an outer edge of the base 51 and the insertion hole 61 of the cover 60. The inclined portion 65 has an inclined plane inclined upward in a direction toward the deep side of the keyboard 54. The tip portion 64 of the moving portion 62 is disposed inside the through hole 75 formed in the base 51. The moving portion 62 is energized toward the deep side (direction of arrow D) by a spring 80 interposed between the base 51 and the moving portion 62.

On the base 51, a lock portion 81 is disposed above (direction of arrow U) the tip portion 64 disposed inside the through hole 75. The lock portion 81 is a rodlike part being part of the cover 60, crossing the through hole 75 and extending in the width direction (direction of arrow W). The lock portion 81 is a part for engaging the engaging piece 68 fixed to the first stand 66. The engaging piece 68 is a flat spring formed in a U shape convex in a standing-up direction relative to the base 51 about the shaft 70, having at a tip thereof a claw 69 that engages the lock portion 81.

Here, in order for the user to fix the sound source module 10 in the flat state relative to the keyboard module 50, first of all, the first stand 66 is brought down about the shaft 70 against the energizing force from the torsion spring 72. As a result, the receiving portion 74 is pressed by the first stand 66, and the second stand 67 is also brought down about the shaft 71 against the energizing force from the torsion spring 73. The engaging piece 68 fixed to the first stand 66 is inserted in the through hole 75 while elastically deformed, and the claw 69 engages the lock portion 81. Accordingly, the first stand 66 and the second stand 67 are maintained in the brought-down state.

Next, the second side portion 15 of the sound source module 10 having the engaging portions 40 and 48 engaged with the keyboard module 50 approaches the base 51, and the second concave portion 25 of the sound source module 10 is superimposed onto the cover 60, the first stand 66 and the second stand 67 of the keyboard module 50. When the claw portion 63 sticking out of the cover 60 interferes with the protrusion 30 of the sound source module 10, the moving portion 62 integrated with the claw portion 63 is energized toward the deep side (direction of arrow D) by the spring 80. Thus, the claw portion 63 and the protrusion 30 engage due to elastic deformation of the spring 80. Accordingly, the sound source module 10 is fixed to the keyboard module 50 while in the flat state. In this state, the first convex portions 26a of the sound source module 10 touch the first stand 66, and the second convex portion 31 of the sound source module 10 is inserted in the insertion hole 61 of the cover 60. The moving portion 62 has an end protruding outside the second side portion 15 of the sound source module 10.

To render the sound source module 10 inclined relative to the keyboard module 50, the user pushes the end of the moving portion 62 protruding outside the second side portion 15 of the sound source module 10. The claw portion 63 integrated with the moving portion 62 disengages from the protrusion 30, and the tip portion 64 of the moving portion 62 pushes the claw 69 of the engaging piece 68. Thus, the engagement between the claw portion 63 and the protrusion 30 is released, and the engagement between the engaging piece 68 (claw 69) and the lock portion 81 is released. As the moving portion 62 is moved, the inclined portion 65 protruding from the moving portion 62 pushes up the second convex portion 31 of the sound source module 10. Thus, the sound source module 10 is moved by that amount accordingly with the engaging portions 40 and 48 as an axis, so as to create space between the back portion 16 of the sound source module 10 and the cover 60 of the keyboard module 50. The first stand 66 is inclined by an amount corresponding to that space by the torsion spring 72, and the engaging piece 68 fixed to the first stand 66 gets out of the through hole 75.

When the user stops pushing the moving portion 62, the spring 80 is restored to return the moving portion 62 to its original position. Since the claw portion 63 integrated with the moving portion 62 interferes with the protrusion 30 of the sound source module 10, as long as the user does not apply force to the sound source module 10 to eliminate the space between the sound source module 10 and the keyboard module 50, the state in which space is formed between the sound source module 10 and the keyboard module 50 is maintained.

Next, when the user lifts the second side portion 15 of the sound source module 10 with the engaging portions 40 and 48 as an axis, as the sound source module 10 is inclined, the first stand 66 and the second stand 67 gradually rise due to restoration force of the torsion springs 72 and 73. As shown in FIG. 12, when a tip of the first stand 66 reaches the position of the first convex portion 26a, the first stand 66 engages the first depression 26. Due to the first convex portion 26a, the first stand 66 and the first depression 26 can be easily engaged. The inclination of the sound source module 10 relative to the keyboard module 50 is determined by the height of the first stand 66 engaged with the first depression 26. By inclining the sound source module 10, the controller 12 on the front portion 11 can be easily controlled.

By inclining the sound source module 10 relative to the keyboard module 50, space can be provided between the back portion 16 of the sound source module 10 and the keyboard module 50. Since the speaker 20 provided in the back portion 16 of the sound source module 10 emits a musical sound, the musical sound can be emitted from the space between the back portion 16 of the sound source module 10 and the keyboard module 50.

When the inclination of the sound source module 10 is increased, the first stand 66 disengages from the first depression 26 due to the restoration force of the torsion spring 72, and the second stand 67 gradually rises due to the restoration force of the torsion spring 73. When a tip of the second stand 67 reaches the position of the second depression 27, the second stand 67 engages the second depression 27. The inclination of the sound source module 10 relative to the keyboard module 50 is determined by the height of the second stand 67 engaged with the second depression 27.

By rising of the first stand 66 and the second stand 67 provided in the keyboard module 50 in a direction away from the base 51, the sound source module 10 supported by the first stand 66 or the second stand 67 is inclined. Thus, compared to the case where a stand is provided in the sound source module 10, the sound source module 10 is supported in a simple manner so as to be inclined.

Since the first stand 66 and the second stand 67 are energized in the standing-up direction by the torsion springs 72 and 73, even if the first stand 66 and the second stand 67 are not touched, by simply inclining the sound source module 10, the first stand 66 and the second stand 67 can be stood by themselves to support the sound source module 10.

When the inclination of the sound source module 10 is increased further, the first stand 66 disengages from the first depression 26 (see FIG. 9). In this state, the flat cable 77 can be connected to the connector 21 of the sound source module 10, or the battery accommodated in the accommodating portion 17 can be replaced, and so on. Since the engaging portions 40 and 48 that engage the sound source module 10 with the keyboard module 50 also serve as an axis for inclining the sound source module 10 relative to the keyboard module 50, the electronic musical instrument 90 has a simple structure. In addition, the sound source module 10 and the keyboard module 50 can be inclined relative to each other and can be easily attached and detached. Since the sound source module 10 is easily installed and removed, the sound source module 10 can be easily exchanged for a favored one.

The engaging portions 40 and 48 are provided on both ends of the base portion 23 in the longitudinal direction, the base portion 23 being provided on the end surface 22 of the sound source module 10 closer to the front portion 11. Since the position of the base portion 23 is biased from the center of the end surface 22 in the thick direction toward the front portion 11, in the electronic musical instrument 90, the substrate having an electric circuit formed thereon or the connector 76 can be disposed on the deep side of the keyboard 54 in the depth direction and below the base portion 23 of the sound source module 10. The transverse board 55 is disposed so as to hide the substrate or the connector 76, and the protruding portion 58 and the hole portion 59 (engaged portions) are provided above the transverse board 55. The engaging portions 40 and 48 of the sound source module 10 engage the engaged portions. Since the substrate or the connector 76 can be arranged utilizing the space below the engaging portions 40 and 48 and the engaged portions, compared to the case where the space is not utilized, the depth of the electronic musical instrument 90 can be reduced.

In the sound source module 10, the side surface 24 of the edge portion 14 is formed in a curved shape convex outward. Thus, even if a gap between the edge portion 14 of the sound source module 10 inclined about the engaging portions 40 and 48 and the keyboard module 50 (keyboard 54) is reduced, the edge portion 14 of the sound source module 10 and the keyboard 54 of the keyboard module 50 can hardly interfere with each other. Since the gap between the edge portion 14 of the sound source module 10 and the keyboard 54 can be reduced, the user can hardly feel incompatibility.

In the keyboard module 50, the connector 76 is provided on the end surface of the keyboard 54 in the depth direction, and the engaging portions 40 and 48 (see FIG. 1) that serve as a rotation axis of the sound source module 10 are provided above the end surface. Thus, a distance between the rotation axis and the connector 76 can be equal to or less than the height of the sidewall 53. Hence, when the inclination of the sound source module 10 is changed about engaging portions 40 and 48, a spatial distance between the connectors 21 and 76 can be prevented from being significantly changed. As a result, if the length of the flat cable 77 is appropriately adjusted in advance, when the inclination of the sound source module 10 is changed, it can be avoided that the flat cable 77 excessively remains or becomes excessively tense.

The connector 76 on the side of the keyboard module 50 is disposed between the second stand 67 and the sidewall 53. The connector 21 on the side of the sound source module 10 is disposed near the sidewall 53 of the keyboard module 50. Thus, compared to the case where the connector 76 is disposed between the second stand 67 and the sidewall 52, the wiring length of the flat cable 77 can be shortened.

The sound source module 10 is supported by the keyboard module 50 using the engaging portions 40 and 48 as the rotation axis. Thus, the mechanism that changes and maintains the inclination of the sound source module 10 relative to the keyboard module 50 can be simplified as the first stand 66 or the second stand 67. In addition, the sound source module 10 can be rotated about the engaging portions 40 and 48 in a direction approaching the keyboard 54 at an angle greater than an inclination angle defined by the first stand 66 and the second stand 67. Thus, the back portion 16 of the sound source module 10 can be widely open. As a result, operations such as replacement of the battery in the accommodating portion 17 provided in the back portion 16 of the sound source module 10 or installation and removal of the flat cable 77 to and from the connector 21, and so on, can be facilitated.

The above illustrates the invention on the basis of the embodiments. However, it is easily understood that the invention is not limited to any of the above embodiments, and various modifications or alterations may be made without departing from the spirit of the invention.

In the above embodiments, the case has been explained where the engaging portion 40 of the sound source module 10 is formed in a shaft shape and the engaging portion 48 is formed in a hole shape (ring shape). However, the invention is not limited thereto. The engaging portions 40 and 48 are properly configured according to their relationship with the engaged portions of the keyboard module 50 combined with the sound source module 10. For example, it is certainly possible to make both the engaging portions 40 and 48 shaft-shaped or hole-shaped (ring-shaped).

In the above embodiments, the case has been explained where one of the engaged portions of the keyboard module 50 is the protruding portion 58 and the other is the hole portion 59. However, the invention is not limited thereto. The engaged portions of the keyboard module 50 are properly configured according to their relationship with the engaging portions 40 and 48 of the sound source module 10 combined with the keyboard module 50. For example, it is certainly possible to make both engaged portions shaft-shaped or hole-shaped (ring-shaped).

In the above embodiments, the case has been explained where the sidewall 53 of the keyboard module 50 is formed in a board shape and the hole portion 59 (through hole) passing through the sidewall 53 in the thickness direction is thus used as the engaged portion. However, the invention is not limited thereto. If the sidewall 53 has a certain thickness, it is certainly possible to use, in place of a through hole, a depression (which does not pass through the sidewall 53) in which the shaft portion 41 of the sound source module 10 is inserted as the engaged portion.

In the above embodiments, the width of the sound source module 10 is set almost equal to an arrangement length of the arranged keyboard 54. However, in the case where the width of the sound source module 10 is less than the arrangement length of the keyboard 54, accordingly, the sidewall 52 and/or the sidewall 53 is moved inward relative to the arrangement direction of the keyboard 54, or the thickness of the sidewall 52 and/or the sidewall 53 is increased inward relative to the arrangement direction of the keyboard 54. Accordingly, the protruding portion 58 provided on the sidewall 52 and the hole portion 59 provided on the sidewall 53 can be engaged respectively with the engaging portions 40 and 48 of the sound source module 10. In addition, in the case where the width of the sound source module 10 is greater than the arrangement length of the keyboard 54, the sidewall 52 and/or the sidewall 53 may be moved outward relative to the arrangement direction of the keyboard 54. At this moment, in the case where the sidewalls 52 and 53 are provided on the base 51, in response to the above, the base 51 is also extended outward relative to the arrangement direction of the keyboard 54.

In the above embodiments, the case has been explained where the first stand 66 and the second stand 67 are provided on the base 51 of the keyboard module 50 while the first depression 26 and the second depression 27 are provided in the back portion 16 of the sound source module 10. However, the invention is not limited thereto. An opposite case to the above is certainly possible where a stand (sound source side support portion) is provided in the sound source module 10 while a depression (keyboard side support portion) which a tip of the stand engages is provided in the keyboard module 50.

In the above embodiments, the case has been explained where the first stand 66 and the second stand 67 are provided at different heights. However, the invention is not limited thereto. It is certainly possible to omit either of the first stand 66 and the second stand 67. Due to omission of either of the first stand 66 and the second stand 67, the inclination of the sound source module 10 cannot be adjusted in two stages. However, it is possible to change the sound source module 10 from a flat state to an inclined state.

In the above embodiments, the case has been explained where the first stand 66 and the second stand 67 provided in the keyboard module 50 engage the first depression 26 and the second depression 27 provided in the back portion 16 of the sound source module 10 and the sound source module 10 is supported in the inclined state. However, the invention is not limited thereto. For example, the following structure may also be used. A stand including a holding structure capable of fixing an object while maintaining the object inclined at a desired angle is provided in the keyboard module 50. By the stand supporting the sound source side support portion provided in the back portion of the sound source module 10 and formed of a plane having certain rigidity, the sound source module 10 is held in the inclined state. Similarly, in the case where the back portion of the sound source module 10 includes the specified holding structure, the keyboard side support portion can be a simple plane.

What is claimed is:

1. A sound source module producing a musical sound, comprising
a front portion;
a back portion located opposite the front portion; and
an edge portion connecting the back portion and the front portion, wherein
the front portion comprises a controller controlled by a user;
the edge portion comprises engaging portions provided spaced from each other on both ends of the edge portion in a longitudinal direction and located on the same straight line;
the engaging portions removably engage a keyboard module comprising a keyboard controlled by the user; and
the back portion comprises a sound source side support portion supporting the front portion in an inclined state relative to the keyboard module engaged with the engaging portions with the engaging portions as an axis.

2. The sound source module according to claim 1, wherein the engaging portions comprise a shaft portion.

3. The sound source module according to claim 2, wherein the engaging portions comprise a spring energizing the shaft portion in an axial direction outward in the longitudinal direction of the edge portion.

4. The sound source module according to claim 3, wherein the shaft portion and the spring are disposed on one of the ends of the edge portion in the longitudinal direction.

5. The sound source module according to claim 3, wherein the edge portion comprises a fixing portion fixing the shaft portion to the edge portion while the spring is compressed to cause the shaft portion to retreat toward the edge portion.

6. The sound source module according to claim 1, wherein a side surface of the edge portion connecting the both ends and the front portion is formed in a curved shape convex outward.

7. The sound source module according to claim 1, comprising a power supply means capable of supplying electricity to the keyboard module.

8. The sound source module according to claim 1, wherein the musical sound is produced based on sound production information produced based on a key pressing command of the keyboard.

9. The sound source module according to claim 8, wherein the production of the musical sound is controlled based on control of the controller.

10. The sound source module according to claim 1, wherein the keyboard module comprises
a base;
a keyboard arranged on the base;
sidewalls facing each other while intersecting a straight line parallel to an arrangement direction of the keyboard; and
engaged portions provided respectively on the sidewalls and located on the same straight line parallel to the arrangement direction of the keyboard, wherein
the engaged portions respectively removably engage the engaging portions.

11. The sound source module according to claim 10, wherein the sound source module is supported in an inclined state by a keyboard side support portion provided on the base with the engaging portions as an axis.

12. An electronic musical instrument comprising:
a sound source module, comprising
a sound source portion producing a musical sound;
a front portion comprising a controller controlled by a user;
a back portion located opposite the front portion; and
an edge portion connecting the back portion and the front portion;
a base;
a keyboard arranged on the base; and
sidewalls facing each other while intersecting a straight line parallel to an arrangement direction of the keyboard, wherein
engaging portions provided spaced from each other on both ends of the edge portion in a longitudinal direction and located on the same straight line respectively removably engage engaged portions provided respectively on the sidewalls and located on the same straight line parallel to the arrangement direction of the keyboard, and
the electronic musical instrument comprises a support portion supporting the front portion of the sound source module in an inclined state relative to the sound source module with the engaging portions as an axis.

13. The electronic musical instrument according to claim 12, wherein the engaging portions comprise a shaft portion.

14. The electronic musical instrument according to claim 13, wherein the engaging portions comprise a spring energizing the shaft portion in an axial direction outward in the longitudinal direction of the edge portion.

15. The electronic musical instrument according to claim 14, wherein the shaft portion and the spring are disposed on one of the ends of the edge portion in the longitudinal direction.

16. The electronic musical instrument according to claim 14, wherein the edge portion comprises a fixing portion fixing the shaft portion to the edge portion while the spring is compressed to cause the shaft portion to retreat toward the edge portion.

17. The electronic musical instrument according to claim 12, wherein a side surface of the edge portion connecting the both ends and the front portion is formed in a curved shape convex outward.

18. The electronic musical instrument according to claim 12, wherein the musical sound is produced based on sound production information produced based on a key pressing command of the keyboard.

19. The electronic musical instrument according to claim 18, wherein the production of the musical sound is controlled based on control of the controller.

20. The electronic musical instrument according to claim 12, wherein the sound source module is supported in an inclined state by a sound source side support portion provided in the back portion of the sound source module with the engaging portions as an axis.
